(19) United States
(12) Patent Application Publication
(10) Pub. No.: US 2024/0335816 A1
(43) Pub. Date: Oct. 10, 2024

(54) AMINE FUNCTIONALIZED FIBRES FOR DIRECT AIR CAPTURE

(71) Applicant: CLIMEWORKS AG, Zürich (CH)

(72) Inventors: Felix TRAUTNER, Zürich (CH); Miriam VON HOLST, Zürich (CH); Nicolas REPOND, Männedorf (CH); Tobias NIEBEL, Zürich (CH)

(73) Assignee: CLIMEWORKS AG, Zürich (CH)

(21) Appl. No.: 18/580,996

(22) PCT Filed: Jul. 19, 2022
(86) PCT No.: PCT/EP2022/070179

§ 371 Date: Jan. 19, 2024

(30) Foreign Application Priority Data
Jul. 21, 2021 (EP) 21186961.5

(51) Int. Cl. B01J 20/26; B01D 53/04; B01D 53/047

(52) U.S. Cl. CPC B01J 20/265; B01D 53/0462; B01D 53/0476; B01D 2253/202; B01D 2253/306; B01D 2257/504; B01J 2220/4812

(57) ABSTRACT

Method for the production of amine functionalized polyacrylonitrile (PAN) fibres, preferably for direct air capture, wherein pristine polyacrylonitrile fibres are added to a solution of tetraethylenepentamine (TEPA) or pentaethylenehexamine (PEHA) at a concentration of tetraethylenepentamine (TEPA) or pentaethylenehexamine (PEHA) of at least 80% v/v, and wherein the mixture is kept, preferably stirred, at a temperature in the range of 120-160° C. for a time span of at least 4 hours, as well as uses of corresponding fibres.

### TECHNICAL FIELD

The present invention relates to methods for producing surface functionalized fibres in particular for direct air capture, to structures based on such fibres as well as to uses of such fibres or structures based on such fibres for carbon dioxide capture, in particular for direct air capture.

### PRIOR ART

The Paris Agreement led to a consensus about the threat of climate change and the need of a global response to keep the global temperature rise well below 2 degrees Celsius above pre-industrial levels. To achieve this target, multiple possibilities have been suggested, from the planting of new forests to technological means. Forestation has broad resonance with the public opinion but the scope and feasibility of such projects is debated and is likely to be less simple an approach as believed.

Among the technological approaches, the most advanced technologies include sequestration of CO2 from point sources such as flue gas capture, and direct capture of CO2 from air, referred to as direct air capture (DAC). Both technological strategies have potential to mitigate climate change.

The specific advantages of CO2 capture from the atmosphere over flue gas capture include: DAC (i) can address the emissions of distributed sources (e.g. cars, planes); (ii) does not need to be attached to the source of emission but can be at a location independent thereof; (iii) can address emissions from the past thus enabling negative emissions if combined with a safe and permanent method to store the CO2 (e.g., through underground mineralization). DAC is also used as one of several means of providing a key reactant for the synthesis of renewable materials or fuels as e.g. described in WO-A-2016/161998.

In terms of suitable capture material, several DAC technologies have been described in literature, such as for example, the utilization of alkaline earth oxides in water to form calcium carbonate as described in e.g. US-A-2010034724. Different approaches comprise the utilization of solid CO2 adsorbents, hereafter named sorbents, which are characterized by the use of a packed bed and where CO2 is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346.

WO-A-2011/049759 describes the utilization of an ion exchange material comprising an aminoalkylated bead polymer for the removal of carbon dioxide from industrial applications.

WO-A-2016/037668 describes a sorbent for reversibly adsorbing CO2 from a gas mixture, where the sorbent is composed of a polymeric adsorbent having a primary amino functionality and having a high specific surface area (calculated with the Brunauer-Emmet-Teller method) of 25-75 m2/g and a specific average pore diameter. The materials are regenerated after capture by applying pressure or humidity swing.

WO-A-2016/038339 describes a process for removing carbon dioxide using a polymeric adsorbent having primary amine units immobilized on a solid support. The regeneration of the sorbent is then done by heating the sorbent in a temperature range between 55 and 75° C. while flowing air through it.

US-A-2012076711 discloses a structure containing a sorbent with amine groups that is capable of a reversible adsorption and desorption cycle for capturing CO2 from a gas mixture wherein said structure is composed of fiber filaments wherein the fiber material is carbon, polyacrylonitrile, rayon, lignin, cellulose, lyocell, polylactic acid, polyvinyl alcohol, poly(ethylene terephthalate), polyacrylic acid, polyvinyl amine or mixtures thereof.

US-A-2018043303 discloses a porous adsorbent structure that is capable of a reversible adsorption and desorption cycle for capturing CO2 from a gas mixture and which comprises a support matrix formed by a web of surface modified cellulose nanofibers. The support matrix has a porosity of at least 20%. The surface modified cellulose nanofibers consist of cellulose nanofibers having a diameter of about 4 nm to about 1000 nm and a length of 100 nm to 1 mm that are covered with a coupling agent being covalently bound to the surface thereof. The coupling agent comprises at least one monoalkyldialkoxyaminosilane.

US-A-2017203249 discloses a method for separating gaseous carbon dioxide from a mixture by cyclic adsorption/desorption using a unit containing an adsorber structure with sorbent material, wherein the method comprises the following steps: (a) contacting said mixture with the sorbent material to allow said gaseous carbon dioxide to adsorb under ambient conditions; (b) evacuating said unit to a pressure in the range of 20-400 mbarabs and heating said sorbent material with an internal heat exchanger to a temperature in the range of 80-130° C.; and (c) re-pressurisation of the unit to ambient atmospheric pressure conditions and actively cooling the sorbent material to a temperature larger or equal to ambient temperature; wherein in step (b) steam is injected into the unit to flow-through and contact the sorbent material under saturated steam conditions, and wherein the molar ratio of steam that is injected to the gaseous carbon dioxide released is less than 20:1.

Zhang et al. (“Balsam-Pear-Skin-Like Porous Polyacrylonitrile Nanofibrous Membranes Grafted with Polyethyleneimine for Postcombustion CO2 Capture”, ACS Appl. Mater. Interfaces 2017, 9, 41087-41098, DOI: 10.1021/acsami.7b14635) report existing studies of amine-containing powder sorbents for postcombustion carbon dioxide (CO2) capture because of their ability to chemisorb CO2 from the flue gas, and present a novel approach for the facile fabrication of flexible, robust, and polyethyleneimine-grafted (PEI-grafted) hydrolyzed porous PAN nanofibrous membranes (HPPAN-PEI NFMs) through the combination of electrospinning, pore-forming process, hydrolysis reaction, and the subsequent grafting technique. They find that all the resultant porous PAN (PPAN) fibers exhibit a balsam-pear-skin-like porous structure due to the selective removal of poly(vinylpyrrolidone) (PVP) from PAN/PVP fibers by water extraction. Significantly, the HPPAN-PEI NFMs retained their mesoporosity, as well as exhibited good thermal stability and prominent tensile strength (11.1 MPa) after grafting, guaranteeing their application in CO2 trapping from the flue gas. When exposed to CO2 at 40° C., the HPPAN-PEI NFMs showed an enhanced CO2 adsorption capacity of 1.23 mmol g−1 (based on the overall quantity of the sample) or 6.15 mmol g−1 (based on the quantity of grafted PEI). Moreover, the developed HPPAN-PEI NFMs displayed significantly selective capture for CO2 over N2 and recyclability. The CO2 capacity retained 92% of the initial value after 20 adsorption-desorption cycle tests, indicating that the resultant HPPAN-PEI NFMs have insufficient long-term stability.

Olivieri et al. (“Evaluation of electrospun nanofibrous mats as materials for CO2 capture: A feasibility study on functionalized poly(acrylonitrile) (PAN)”, Journal of Membrane Science 546 (2018) 128-138, http://dx.doi.org/10.1016/j.memsci.2017.10.019) fabricated a new type of nanostructured materials for CO2 capture processes, based on poly (acrylonitrile), PAN, a polymer almost impermeable to CO2, but easily functionalizable and spinnable. The preparation involved amine functionalization of PAN powder, electrospinning of the powder to form a nanofibrous mat with a large surface area, and compression of the mat to obtain dense membranes for facilitated transport of humid CO2. The functionalization step was carried out with different routes: amination with hexamethylene diamine or ethylene diamine, and basic hydrolysis. The final amine content in the polymer could be tuned varying the reaction type and conditions, although high functionalization degrees led to crosslinking, which made the powder insoluble. The dry CO2 uptake was measured at various stages of the preparation, in order to assess separately the effect of chemical functionalization and surface area enhancement on the material capture ability. Such tests indicated that both chemical and morphological changes of the neat polymer enhanced the dry CO2 sorption capacity, although the increase of surface area yielded the largest improvement. CO2 permeation tests in humid conditions were carried out on the compacted membranes, indicating that the materials functionalized via direct amination exhibit a behavior compatible with the facilitated transport mechanism, with CO2 permeability reaching 83 Barrer, increasing by 17 times with respect to the dry state value, at a relative humidity of 50%. Membranes functionalized via hydrolysis did not show such a behavior, maybe because the amine functionalities were consumed by an unwanted reaction. The electrospinning process seemed the key factor of the approach, as the large surface area of electrospun mats allowed to obtain membranes with a higher permeability than the original ones, and a large availability of amine groups useful for humid CO2 capture.

Kuang et al. (“Adsorption behavior of CO2 on amine-functionalized polyacrylonitrile fiber”, Adsorption, 2019, Springer Verlag, https://doi.org/10.1007/s10450-019-00070-0) proposes using efficient and stable solid amine adsorbents to capture CO2 to reduce the CO2 concentration in the atmosphere. A series of solid amine-containing fibrous adsorbent for CO2 capture were prepared by direct modification of polyacrylonitrile (PAN) fibers with amination reagents, including diethylenetriamine (DETA), triethylenetetramine (TETA), tetraethylenepentamine (TEPA) and polyethyleneimine (PEI). Abundant amine groups were reported to be introduced on the PAN surface owing to the reactivity between nitrile group and amino group. The effects of the type and structure of amination reagents on the swelling properties and CO2 adsorption capacities of the as-prepared adsorbents were investigated. The results indicated that chemical modification of PAN fibers with amine compounds could greatly increase the CO2 adsorption capacity of the aminated adsorbents. The adsorption capacities of the adsorbents correlated well with the content of amino groups. PAN-TETA and, to a lesser extent also PAN-TEPA, showed higher CO2 adsorption capacities and better stability than PAN-DETA and PAN-PEI. It is reported, as water molecules could take part in and facilitate the CO2 adsorption, that the CO2 adsorption capacity of amine-modified fibers would be strongly dependent on the swelling property.

JP2018144022 proposes a polymer membrane for separating carbon dioxide from other gases with high selectivity, a method for producing the same, and a method for separating a gas with the polymer membrane. The polymer membrane contains a water-soluble polymer, and at least one amine compound selected from a group including also polyethylene polyamine. A non-cyclic, continuous membrane separation process is proposed by permeation driven by a pressure gradient. The conditions mentioned are static conditions during this process. The document further aims at separating CO2 from highly concentrated streams (flue gas or alike), experimental evidence is for a 36% v/v stream CO2 in N2.

CN104923176 discloses a dendritic high-density solid amine fiber material and a preparation method therefor. Organic fibers and natural fibers are used as matrix fibers, the matrix fibers pretreated by alkali liquor are radiated by using gamma rays of cobalt-60, and a Michael addition and amide substitution reaction is performed for chemical modification through graft acrylic acid monomers, amination substitution reaction, amino and unsaturated monomers so as to prepare the dendritic high-density solid amine fiber material. The fiber material is high in amido density, good in heat stability and chemical stability and high in adsorption capacity of acid gas, and can be regenerated through thermal desorption recycle; moreover, the fiber material has an antibacterial action, and has wide application prospects in the fields of environmental management, medical materials, functional garment materials and the like.

### SUMMARY OF THE INVENTION

It is an object of the present invention to make available adsorber structures for direct air capture or more generally for capturing carbon dioxide from air streams, which on the one hand have a high mechanical stability, in particular also when undergoing large number of adsorption and desorption cycles, under variable temperature and/or humidity conditions, and which on the other hand show a high carbon dioxide capture capacity which is stable again also for a large number of adsorption and desorption cycles. Further the corresponding structures shall be producible with high efficiency and they shall be amenable to processing into suitable adsorber elements.

According to a first aspect of the present invention it relates to a method for the production of amine functionalized polyacrylonitrile fibres (AFPF), preferably for direct air capture. According to the proposed method pristine polyacrylonitrile fibres are combined with a solution of at least one of tetraethylenepentamine (TEPA) and pentaethylenehexamine (PEHA) at a concentration of tetraethylenepentamine (TEPA), pentaethylenehexamine (PEHA), or the combination thereof, of at least 80% v/v, and subsequently the mixture is kept, preferably stirred, at a temperature in the range of 120-160° C. for a time span of at least 4 hours.

The proposed method uses the reactivity of the nitrile groups of the PAN fibres for the functionalization of the PAN fibres and can be carried out with loose fibres but also with fibres that already take the form of some kind of aggregate structure, like for example in a woven or nonwoven. The term “mixture” used in the context of the method correspondingly also includes the situation where the fibres in an aggregated form are immersed in a corresponding solution or are impregnated with a corresponding solution.

In other words the method for the production of the functionalized polyacrylonitrile fibres can be implemented using loose fibres as starting material or using a fibre or yarn, a woven, nonwoven, knitted or paper-like, cohesive structure, which may even be a self-supporting structure, which contains polyacrylonitrile fibres and possibly other fibres different from polyacrylonitrile fibres (for example for adding structural properties) or a corresponding self-supporting structure which consists of such polyacrylonitrile fibres which can then be functionalized. Preferably the method is carried out using loose polyacrylonitrile fibres or a nonwoven made of polyacrylonitrile fibres. In the latter case the nonwoven is typically immersed or impregnated with the solution of at least one of tetraethylenepentamine (TEPA) and pentaethylenehexamine (PEHA) at a concentration of tetraethylenepentamine (TEPA), pentaethylenehexamine (PEHA), or the combination thereof, of at least 80% v/v, and it is then kept at a temperature in the range of 120-160° C. for a time span of at least 4 hours. Alternatively, of course first the method can be carried out using loose pristine fibres and then these fibres are subjected to an aggregation process to form a cohesive, preferably self-supporting structure, for example a process to form a nonwoven.

Using these processing conditions fibres (or correspondingly aggregate structures for example nonwoven structures) can be produced which on the one hand show a high carbon dioxide capture capacity, in particular also over a large number of cycles, and under variable conditions, and wherein the production process shows a high yield.

A material and reaction conditions parameter screening has been performed to optimize the synthesis of amine functionalized PAN fibre sorbents.

The amination was surprisingly more successful at the claimed TEPA concentrations with best results using a 90% v/v aqueous solution. Increasing the reaction temperature to 130° C. further helped improving the quality of the sorbent. The reaction time should be at least 4 h.

We find that fibrillation of the base PAN fibre material seems an advantage, if not under certain circumstances a prerequisite for satisfying CO2 adsorption after modification with TEPA. Non-fibrillated fibres (partially even with high SSA) as well as commercial PAN fabrics made from such materials often perform poorly. Within the boundaries of the study, the best results were achieved for STW DIMAXA 87504 F fibres reacted with TEPA 90% v/v aqueous solution at 130° C. for a 6 h according to the standard synthesis procedure described below. Depending on the adsorption conditions this material adsorbs more than 2 mmol_CO2/g_Sorbent. The fibres can be arranged into two dimensional sheets which can then be structured into a three-dimensional adsorber structure.

According to a first preferred embodiment of the proposed method, the concentration of the solution of tetraethylenepentamine (TEPA) is at least 85% v/v, preferably in the range of 85-95% v/v.

The solution of tetraethylenepentamine (TEPA) is typically a solution thereof in water or an alcoholic organic solvent, or in a mixture thereof.

Using ethylene glycol instead of water as solvent can be beneficial at lower TEPA concentration.

The solution of tetraethylenepentamine (TEPA) is preferably a purely aqueous solution.

The mixture is kept, preferably stirred, at a temperature in the range of 125-160° C., preferably in the range of 130-150° C.

Normally, the mixture is kept, preferably stirred, for a time span in the range of 4-8 hours, preferably in the range of 5-7 hours.

According to a particularly preferred embodiment, the pristine polyacrylonitrile fibres are fibrillated fibres. Fibrillated fiber is the general term for fibers that have been processed (refined) to develop fibers with a higher surface area, branched structure. The fibres can be treated mechanically for fibrillation, creating additional micro or nano fibrils that are attached to the principle fibrillated network. Further preferably the fibres are nano-fibrillated fibres. Typically, before fibrillation the fibres have dtex values in the range of 1.5-3, preferably in the range of 2-2.5. Alternatively speaking, the fibres have a diameter, assuming a circular cross-section, in the range of 5-50 micro metre, preferably in the range of 10-20 micro metre. Further preferably, the length of the fibres before fibrillation is in the range of 2-10 mm, preferably in the range of 3-5 mm.

Preferably, the pristine polyacrylonitrile fibres, preferably in the form of fibrillated fibres, have a specific surface area of at least 10 m2/g, preferably of at least 20 m2/g, and most preferably in the range of 20-60 m2/m, or in the range of 25-45 m2/g.

The pristine polyacrylonitrile fibres, again preferably in the form of fibrillated fibres, can have a Schopper-Riegler value in the range of 18-70° SR, preferably in the range of 20-60° SR. The Schopper-Riegler value is a measure commonly used to express the degree of grinding of a suspension of fibers in water. It is a term widely used in paper production. The grinding degree is expressed in degrees Schopper-Riegler (° SR). The process for determination of the Schopper-Riegler value is standardized in ISO 5267/1.

Subsequently the fibres are either, normally after drying at least partially, processed to form a cohesive structure (which may be self-supporting or not), preferably in the form of a woven, nonwoven, knitted or paper-like structure or a combination thereof, or are filled into an air permeable container suitable and adapted for a direct air capture process.

The invention furthermore relates to a fibre produced according to a method as given above or yarns produced therefrom.

In addition, the present invention relates to a woven, nonwoven, knitted or paper-like cohesive, preferably self-supporting structure comprising or consisting of fibres or yarns as given above.

Preferably, the self-supporting structure based on the fibres takes the form of a fleece. The fleece is preferably obtained in a wet laying process, and experimental evidence shows that in particular fibrillated fibres produced according to the invention show good carbon dioxide capture properties in particular in direct air capture conditions where steam is used for desorption. Corresponding fleeces can be embedded into actual adsorber structures.

In a preferred embodiment, fibres produced according to a method as given above are arranged into to a nonwoven sheet or element by wet laying. In this procedure the fibres are suspended in an aqueous medium and preferably separated into single fibers, optionally mixed with additional raw materials such as auxiliary fibres, binding agents (e.g. styrene and/or acrylic and/or butadiene and/or ethylene binders including polyvinylacetatacrylates, polyvinylacetatmaleinate, acrylate/acrylonitrile, polyacrylate or mixtures thereof) etc to form a fibrous suspension slurry and finally laid in wet state to form a nonwoven fabric in a mesh-forming and dewatering mechanism. Consequently, said fabric can be finished by applying one or more steps that aim for instance at drying, activating any binding agents, improving mechanical or surface properties, calibrating the shape and geometry, etc and that can encompass for instance the application of heat, pressure, different atmospheres or additional compounds. This wet laying process can also be carried out before surface functionalization of the fibres.

The nonwovens produced by said wet laying procedure have preferentially a thickness of 0.1-4 mm, preferentially of 0.4-2 mm and/or a grammage of 50-600 g/m2, preferentially of 100-300 g/m2.

In a preferred embodiment of said wet laying procedure the, preferentially fibrillated, fibres produced according to a method as given above are mixed during the slurry formation with auxiliary fibres in an amount of 1 to 30% by weight. Such auxiliary fibres can be multi-component or single-component fibres or a combination of these in any ratio, consisting of and/or containing fibres based on e.g. aramide, basalt, carbon, cellulose, cotton or other natural fibres, glass, mineral wool, polyacrylonitrile, polyamide, polyester, polyethylene, polypropylene, polyvinylalcohol or a combination thereof, for instance in particular PET/PET or PET/PE bi-component binder fibres or PET fibres to improve the mechanical stability. After wet laying a fabric in said procedure, the fabric sheet can be at least partially dried and then subjected to a combined application of pressure and heat, e.g. by calendaring or in a heated double belt press, aiming at calibrating the thickness and if applicable activating the used binder fibres.

In another preferred embodiment of said wet laying procedure a dispersion of polymer binder particles is added to the fibre slurry prior to the fabric formation step in an amount of 1 to 15% relative to the weight of the amine functionalized PAN fibres, additionally or alternatively auxiliary fibres can be added in an amount of 0-20% by weight. Here too, the wet laid fabric sheet is at least partially dried and then preferably subjected to a combined application of pressure and heat, e.g. by calendaring or in a heated double belt press, aiming at calibrating the thickness and if applicable activating the used binder particles and/or fibres.

A further object of the present invention is an air permeable container containing fibres or aggregate cohesive structures such as non-wovens made therefrom as given above. Also possible are frames which span or carry such cohesive structures.

Yet another object of the present invention is the use of a fibre as given above for separating gaseous carbon dioxide from a gas mixture, preferably from at least one of ambient atmospheric air, flue gas and biogas, preferably direct air capture, in particular using a temperature, vacuum, or temperature/vacuum swing process, preferably using a process in which injecting a stream of partially or fully saturated or superheated steam by flow-through is used for inducing an increase of the temperature of the sorbent material to a temperature between 6° and 110° C., starting the desorption of CO2.

The polyacrylonitrile based fibres, e.g. in a non-woven structure, are preferably to be used for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material with theses fibres adsorbing said gaseous carbon dioxide in a unit, wherein the method comprises at least the following sequential and in this sequence repeating steps (a)-(e):
(a) contacting said gas mixture with the sorbent material to allow at least said gaseous carbon dioxide (parts thereof or essentially all of the CO2) to adsorb on the sorbent material by flow-through through said unit (and thus through and/or over the sorbent material adsorbing at least part of said gaseous carbon dioxide), in case of ambient atmospheric air as gas mixture under ambient atmospheric pressure conditions and ambient atmospheric temperature conditions (if ambient atmospheric air is pushed/pulled through the device using a ventilator or the like, this is still considered ambient atmospheric pressure conditions in line with this application, even if the air which is pushed/pulled through the reactor by the ventilator has a pressure slightly above or below the surrounding ambient atmospheric pressure, and the pressure is in the ranges as detailed above in the definition of “ambient atmospheric pressures”) and in other cases under temperature and pressure conditions of the supplied gas mixture, in an adsorption step;
(b) isolating said sorbent material with adsorbed carbon dioxide in said unit from said flow-through, preferably while essentially maintaining the temperature in the sorbent;
(c) inducing an increase of the temperature of the sorbent material, preferably to a temperature between 6° and 110° C., starting the desorption of CO2. This is e.g. possible by injecting a stream of partially or fully saturated or superheated steam, preferably by flow-through through the unit and over/through the sorbent, and thereby inducing an increase of the temperature of the sorbent material to a temperature between 6° and 110° C., starting the desorption of CO2;
(d) extracting at least the desorbed gaseous carbon dioxide from the unit (preferably most or all of the desorbed gaseous carbon dioxide) and separating gaseous carbon dioxide from steam, preferably by condensation, downstream of the unit;
(e) bringing the sorbent material, in case of ambient atmospheric air as gas mixture, to ambient atmospheric temperature conditions and ambient atmospheric pressure conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature +25° C., preferably +10° C. or +5° C.), and in other cases to the temperature and pressure conditions of the supplied gas mixture.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.5 to 1.1 barabs and typically ambient atmospheric temperature refers to temperatures in the range of −40 to 60° C., more typically −30 to 45° C. The gas mixture used as input for the process is preferably ambient atmospheric air, so it is a DAC process, i.e. air at ambient atmospheric pressure and at ambient atmospheric temperature, which normally implies a CO₂ concentration in the range of 0.03-0.06% by volume. However, also air with lower or higher CO₂ concentration can be used as input for the process, e.g. with a concentration of 0.1-0.5% by volume, so generally speaking preferably the input CO₂ concentration of the input gas mixture is in the range of 0.01-0.5% by volume. However, also flue gas can be the source, in this case the input CO₂ concentration of the input gas mixture is typically in the range of up to 20% or up to 12% by volume, preferably in the range of 1-20% or 1-12% by volume.

Preferably, in the adsorption step (a) the method is carried out under conditions that the gas mixture or the ambient atmospheric air passing through the sorbent material at least during 5% or 10% or 50% of the cycles in one day, one month and/or or over one year, has a relative humidity varying in the range of 5-100% RH, 10-98% RH or 20-95% RH or 50 to 92% RH, preferably in the range of 30-95%.

Furthermore, the present invention relates to a unit for separating gaseous carbon dioxide from a gas mixture, preferably from at least one of ambient atmospheric air, flue gas and biogas, preferably a direct air capture unit, comprising at least one reactor unit containing sorbent material suitable and adapted for flow-through of said gas mixture,
wherein the reactor unit comprises an inlet for said gas mixture, preferably for ambient air, and an outlet for said gas mixture, preferably for ambient air during adsorption,
wherein the reactor unit is heatable to a temperature of at least 60° C. for the desorption of at least said gaseous carbon dioxide and the reactor unit being openable to flow-through of the gas mixture, preferably of the ambient atmospheric air, and for contacting it with the sorbent material for an adsorption step, wherein preferably the reactor unit is further evacuable to a vacuum pressure of 400 mbar(abs) or less,
wherein the sorbent material preferably takes the form of an adsorber structure comprising an array of individual adsorber elements, taking the form of a woven, nonwoven, knitted or paper-like cohesive, preferably self-supporting structure as given above or of an air permeable container as given above, which preferably offers selective adsorption of CO2 in the presence of moisture or water vapor, wherein preferably the adsorber elements in the array are arranged essentially parallel to each other and spaced apart from each other forming parallel fluid passages for flow-through of said gas mixture, preferably of ambient atmospheric air and/or steam,
at least one device, preferably a condenser, for separating carbon dioxide from water, wherein preferably at the gas outlet side of said device for separating carbon dioxide from water, preferably said condenser, there is at least one of, preferably both of a carbon dioxide concentration sensor and a gas flow sensor for controlling the desorption process.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a reaction scheme of polyacrylonitrile with linear ethylenimine oligomers;

FIG. 2 shows loading (lower line, right y-axis) and breakthrough (upper line, left y-axis) curves for AFPF1 (TEPA functionalized PAN), measured on device B at “20° C., 65% RH”;

FIG. 3 shows loading (lower line, right y-axis) and breakthrough (upper line, left y-axis) curves for AFPF2 (PEI functionalized PAN), on device B at “20° C., 65% RH”;

FIG. 4 shows CO2 equilibrium capacity for AFPF1 as determined on device B in the given set conditions;

FIG. 5 shows the reaction temperature screening from 95 to 150° C., STW DIMAXA 87504 T+70% v/v TEPA aq. sol, 6 h reaction time, measured on device A;

FIG. 6 shows the reaction temperature screening from 120 to 150° C., STW DIMAXA 87504 T+90% v/v TEPA aq. sol, 6 h reaction time, measured on device A, bars: CO2 loading capacity (left y-axis), line: weight gain (right y-axis);

FIG. 7 shows the reaction time screening from two to eight hours, STW DIMAXA 87504 T+90% v/v TEPA aq. sol, temperature 140° C., measured on device A;

FIG. 8 shows the amine concentration screening from 50% v/v to 100% v/v TEPA aq. sol +STW DIMAXA 87504 T, temperature 120° C., 6 h reaction time; measured on device A;

FIG. 9 shows a comparison of effect of amine compound on CO₂ uptake capacity, synthesis as described in the text (70% v/v aq. amine solution (Pz 36% wt)+STW DIMAXA 87504 T, temperature 120° C., 6 h reaction time), measured on device A, data point for PEI measured on device B;

FIG. 10 shows a comparison of CO₂ uptake capacity for different aminated fibres (70% v/v aq. sol TEPA, temperature 120° C., 6 h reaction time), measured on device A (bars, left y-axis) and pristine fibre SSA as determined by N2 adsorption (line, right y-axis);

FIG. 11 shows a correlation between CO₂ uptake capacity and pristine fibre SSA for fibrillated fibres (DIMAXA type) unfibrillated fibres (PAC type) and commercial PAN nonwovens (Freudenberg type), CO₂ capacities were determined on device A for fibrillated and fibrillated fibres and on device B for nonwovens, SSA is determined by N2 adsorption;

FIG. 12 shows a comparison of CO2 uptake capacity in different climatic conditions for AFPF materials based on different fibrillated DIMAXA fibres synthesized in two sets of conditions, measured on device B (missing values were not measured due to machine errors);

FIG. 13 shows a comparison of CO2 uptake capacity in different climatic conditions for AFPF materials based STW DIMAXA 87504 T synthesized under different conditions, measured on device B (missing values were not measured due to machine errors).

FIG. 14 a) shows the CO2 uptake for 15 consecutive cycles measured on a parallel passage reactor composed of fleece sample B, the uptake is normalized by the total CO₂ uptake after ˜240 minutes for cycle 1; b): shows the corresponding normalized CO₂ uptake after ˜240 min for all cycles.

### DESCRIPTION OF PREFERRED EMBODIMENTS

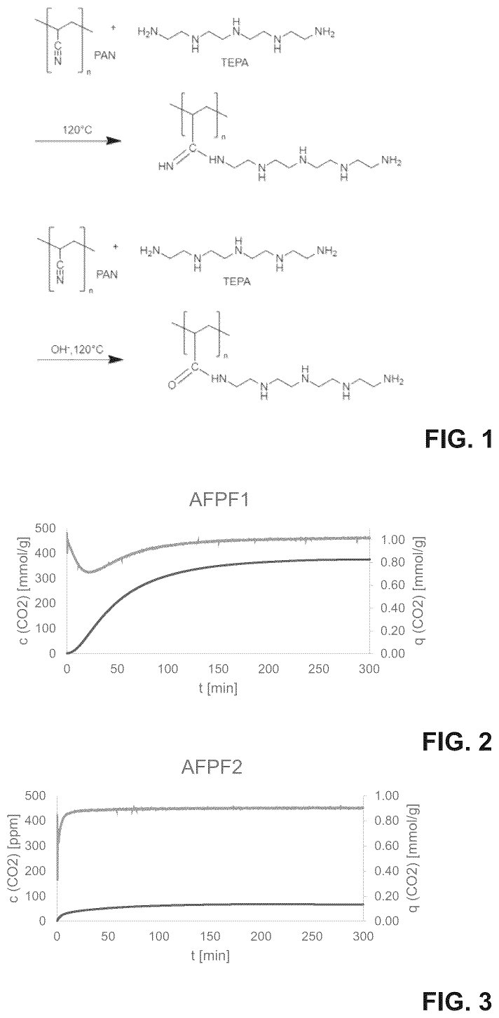

Owing to the reactivity of chemically accessible surface nitrile groups on fibrous PAN with aliphatic alkylene amines functional materials containing amidine, amide and amine groups are readily prepared (see FIG. 1).

Such modified fibres have been investigated in a range of applications. These include separation of heavy metal ions from aqueous solutions, utilization as heterogeneous catalyst with immobilized heavy metal ions or gas separation membranes and capturing of flue-gas-like concentrations of carbon dioxide, but as is well known to the skilled person, sorbent materials for CO2 flue gas capture are not automatically suitable for direct air capture for a number of reasons.

Different granular amine-based sorbent materials can be used in a variety of direct air capture (DAC) plants and process generations. These may come, however, with limitations regarding maximum flow velocities linked to allowable pressure drops and the resulting cost implications due to increased energy consumption. Structured adsorbers which allow higher flow velocities at low pressure drop combined with improved adsorption kinetics present a potential solution to overcome the limitations. One such approach is based on amine functionalized polyacrylonitrile (PAN) fibres arranged into textile materials (yams, wovens, nonwovens or paper-like materials) and assembled in structured adsorbers.

PAN fibres can be functionalized with amines among them the four following compounds: diethylenetriamine (DETA), triethylenetetramine (TETA), tetraethylenepentamine (TEPA) and polyethyleneimine (PEI). The synthesis can be conducted in aqueous medium, at e.g. 120° C. and 70% v/v amine concentration (reflux) for 6 hours. These synthesis parameters were utilized in the first experiments of the present work, conducted with TEPA (AFPF1, AFPF standing for “amine functionalized PAN fibres”) and PEI (AFPF2) as aminating agents. The carbon dioxide uptake of AFPF1 was higher than that of AFPF2 as can be seen in FIG. 2 and FIG. 3.

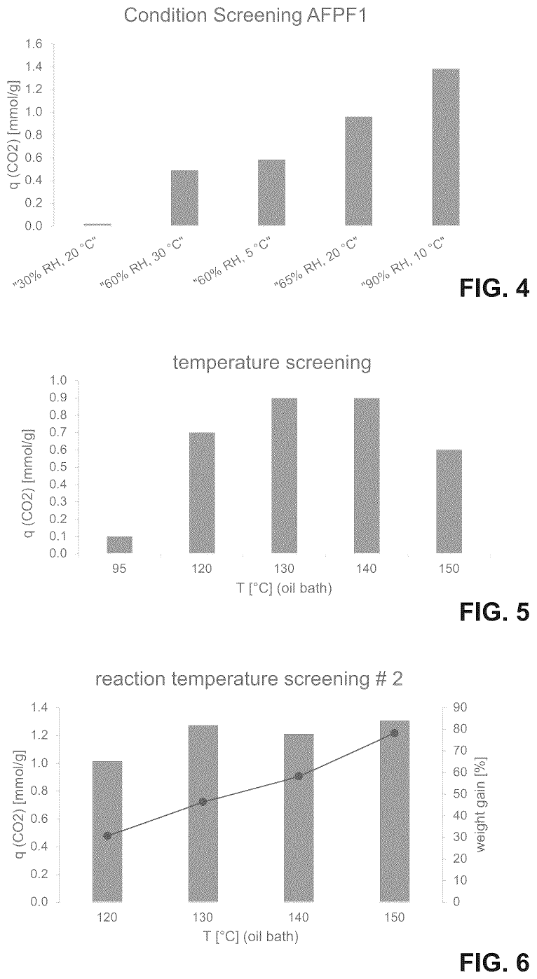

An adsorption condition screening was performed for AFPF1 on device B, revealing that AFPF materials perform best at low temperatures and high humidity (90% RH and 10° C.), see FIG. 4.

Further, a leaching test conducted by soaking AFPF1 in water for one hour showed no change in pH of the water by pH strip. This shows that the TEPA is actually bound covalently to the PAN fibre and that it is not only physically adsorbed or impregnated.

Starting from said procedure the effect of a number of different reaction parameters and reactants were tested on the fibre Type DIMAXA 87504T as available from Schwarzwälder Textil-Werke (STW) Heinrich Kautzmann GmbH, DE. Additionally, a number of fibre types was screened in the standard reaction conditions outlined below. Finally, the best method and the best fibres were combined. The examined parameters and fibres are summarized in Table 1.

TABLE 1
Varied conditions and materials:

| | | | | | | Oll bath |
|---|---|---|---|---|---|---|
| | | | Concentration | Duration | | temperature |
| Fibre | Amine | Solvent | [% v/v] | [h] | Atmosphere | [° C.] |
| STW | TEPA | H₂O | 50 | 2 | Air | 95 |
| DIMAXA | | | | | | |
| 87504 T | | | | | | |
| STW | TETA | Ethylene | 60 | 4 | N₂ | 120 |
| DIMAXA | | glycol | | | | |
| 87204 T | | | | | | |
| STW | PEHA | | 70 | 5 | | 130 |
| DIMAXA | | | | | | |
| 87504 F | | | | | | |
| STW | PEI | | 80 | 6 | | 140 |
| DIMAXA | | | | | | |
| 87203 F | | | | | | |
| STW | Piperazine | | 90 | 7 | | 150 |
| PAC | | | | | | |
| 254/2.1/ | | | | | | |
| 8 F | | | | | | |
| STW | | | 100 | 8 | | |
| PAC gl | | | | | | |
| 2.5/8 | | | | | | |
| STW | | | | | | |
| PAC hm | | | | | | |
| 6.7/10 | | | | | | |

All materials were characterized by measuring the CO2 breakthrough curves in the device A at 60% RH, 30° C. (see below). Integration yielded the CO2 equilibrium capacity of the different materials which is used to compare the synthesis varieties. Selected materials were tested in additional conditions on device B as indicated below.

### Reaction Temperature

Two temperature screenings have been carried out in accordance with the standardized synthesis protocol described. Firstly, the effect of temperature on observed equilibrium capacities of resulting materials was determined in the amination of STW DIMAXA 87504 T with 70% v/v aq. TEPA for six hours. The results are depicted in FIG. 5 which shows the obtained capacity rises with increased reaction temperature up to until 130° C. Heating to a temperature above 140° C. reduced the capacity again slightly.

Another temperature screening at a higher TEPA concentration (90% v/v) was conducted with the remaining parameters staying constant (omitting 95° C.). With the reduced water content, a higher effective temperature of the reaction mixture is expected. The results are depicted in FIG. 6. Overall, the capacities are higher than at 70% v/v TEPA in the reaction mixture reaching to about 1.3 mmol/g. Beyond 130° C. there is barely any increase in observed capture capacities. Curiously, in the first temperature screening there is a drop in capture capacity observed for the material prepared at 150° C. This is not the case for the latter experiment. Since only the concentration of aminating agent was changed it seems counterintuitive, reasons for this are unknown.

Interestingly, by increasing the reaction temperature, the weight gain of the product rose from 46% at 130° C. to 78% at 150° C. In other words, the synthesis yield of sorbent material with the same CO2 adsorption capacity could be increased by more than 20% with an increased temperature. This observation can have important implications for the optimization of upscaling ventures as it opens a field for cost optimization regarding reaction (and heating) time and temperature (i.e. energy consumption) on the one side and yield, amine content and amine efficiency on the other hand that will require additional attention in the future.

### Reaction Time

The effect of reaction time was investigated in the amination of STW DIMAXA 87504 T fibre with TEPA (90% in water) at 140° C. The reaction was conducted in accordance with the direction given below. After the indicated intervals samples were taken from the flask and worked up separately.

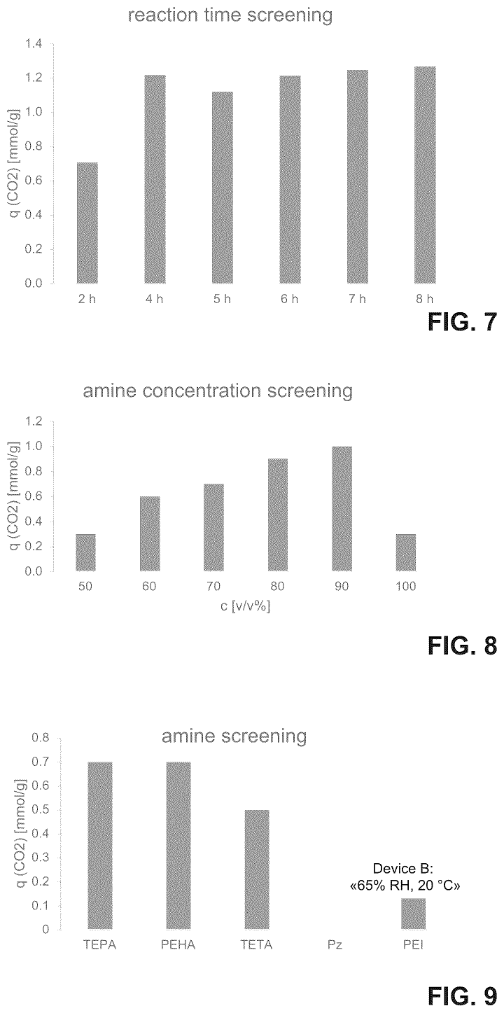

It was found that by prolonging the reaction time beyond four hours there were only minor improvements in observed capture capacities of the resulting materials which lie all in the range of 1.2±0.1 mmol_CO2/g_sorbent. The findings are depicted in FIG. 7.

Conclusively, the reaction mixture should be hold at the set temperature for at least 4 h during the synthesis.

### Concentration of Amines

To determine the effect of amine concentration during the synthesis, STW DIMAXA 87504 T was aminated in a series of experiments covering a range of 50% v/v to 100% v/v in 10% v/v increments. The remaining parameters were 120° C. oil bath temperature, six hours reaction time and TEPA as aminating reagent. The results are depicted in FIG. 8. A steady incline in equilibrium capacity of resulting materials can be observed from 50% v/v to 90% v/v. This might be attributed to an increasing reaction temperature inside the vessel due to the reduced water content (TB(H2O)=100° C.; TB(TEPA)=340° C.) and gave rise to the second temperature screening at elevated TEPA concentration reported above. There is a sudden decline to be observed going from 90% v/v to 100% v/v.

### Synthesis In Ethylene Glycol

The formation of a gas/white fog was observed during the workup of several reactions when the flask was opened to air. Bubbling was not observed. The gas was tested with a pH strip and its blue coloration towards basic components hinted towards ammonia formation during the reaction. This finding gave rise to the hypothesis that the presence of water might induce the formation of ammonia.

This mechanism also includes the formation of amide functionalities, inactive towards carbon dioxide capture (see FIG. 1). Consequently, it was considered that employing water as solvent may lead to materials with decreased capture performance. Therefore, ethylene glycol, a solvent with a higher boiling point and lower acidity than water, was investigated in the functionalization of PAN fibres.

An additional potential advantage of ethylene glycol over water is the higher boiling point which may lead to higher reaction temperature in the flask at moderate amine concentrations.

The results of corresponding experiments point towards a hypothesis that water plays a role in the amination of surface nitrile groups in PAN. The initially observed high CO2 capacity of sorbents prepared in ethylene glycol can likely be attributed to the more beneficial humid base fibres employed in that experiment combined with a higher reaction temperature that was achieved by using ethylene glycol instead of water at the lower TEPA concentration of 70% v/v. In later experiments at higher concentration of amine this effect was less pronounced since the reaction mixture also reaches a higher temperature in this case despite the use of water. Ethylene glycol as reaction solvent thus did not provide any advantages and in fact led to material with slightly lower CO₂ uptake capacity.

Synthesis under Nitrogen Atmosphere

There is no significant difference in equilibrium capacity with materials prepared under either air or nitrogen atmosphere. This leads to the conclusion that the presence of oxygen at ambient levels during the reaction synthesis likely does not lead to any oxidation that would alter the capture performance of the respective AFPF material.

### Amine Screening

A series of aliphatic amines as aminating reagents were investigated regarding their ability to react with the nitrile groups of STW DIMAXA 87504 T. These were TEPA. TETA, pentaethylenehexamine (PEHA), piperazine (Pz) and PEI. The parameters were set at standard conditions described below: oil bath temperature 120° C., 70% v/v aq. amine concentration in excess and six hours reaction time. Since Pz is not as well miscible with water as are the other amines a solution of 40 g Pz in 70 mL water for 5 g base fibres was utilized in that case. The CO₂ uptake capacities of the resulting materials are presented below in FIG. 9. Since the synthesis parameters were changed for the experiment with Pz there can't be made any direct comparison with the rest of amines.

It was observed that materials prepared with TEPA and PEHA had similar capacities. Pz was seemingly unable to aminate the fibres, and PEI yielded a material with much lower CO₂ capacity than the ones prepared from discrete aliphatic chains. These findings stand in contrast to the observations in the prior art. There it was found that for capturing flue gas like concentrations of CO2 (10%) TETA was superior as an amination agent in comparison to TEPA (25% higher capacity for material prepared with TETA). In the current study, a 40% higher equilibrium capacity was observed for the material prepared with TEPA which was accordingly chosen as standard amine for all other investigations.

### Fibre Screening

Two alternative classes of PAN fibres were investigated regarding their ability to be aminated under standard conditions. All fibers were supplied by Schwarzwälder Textil Werke (STW), Schenkenzell, Germany:
1) Fibrillated fibres of the class STW DIMAXA. These fibres are mechanically stressed (ground), which results in fibrillation of the fibres. This significantly increases the surface area and, potentially, the accessibility of surface nitrile groups for chemical conversion. Note, that the fibrillation process is performed in an aqueous suspension, so fibres can be sourced from STW in moist (F=feucht) or in a dried (T=trocken) form.
2) Non-fibrillated fibres of the class STW PAC. These fibres are not fibrillated and have typically a lower surface area.

The specific surface area (SSA) of some unfunctionalized fibre types was determined by N2 isotherm measurements (BET method, section below). It is evident that all fibrillated fibres used have an SSA of at least 25 m2/g, see Table 2. For the non-fibrillated fibres: PAC gl 2.5/8 and PAC hm 6.7/10 show a rather low SSA of about 1 m2/g.

TABLE 2
Selected base fibres and their specific surface
area (SSA), measured by BET-Method

| Fibre | Type | Specific surface area | |
|---|---|---|---|
| DIMAXA 87504 T | fibrillated | 52.2 | m²/g |
| DIMAXA 87504 F | fibrillated | 38.4 | m²/g |
| DIMAXA 87204 T | fibrillated | 25.5 | m²/g |
| DIMAXA 87203 F | fibrillated | 36.9 | m²/g |
| PAC gl 2.5/8 | Non-fibrillated | 1.1 | m²/g |
| PAC hm 6.7/10 | Non-fibrillated | 1.0 | m²/g |

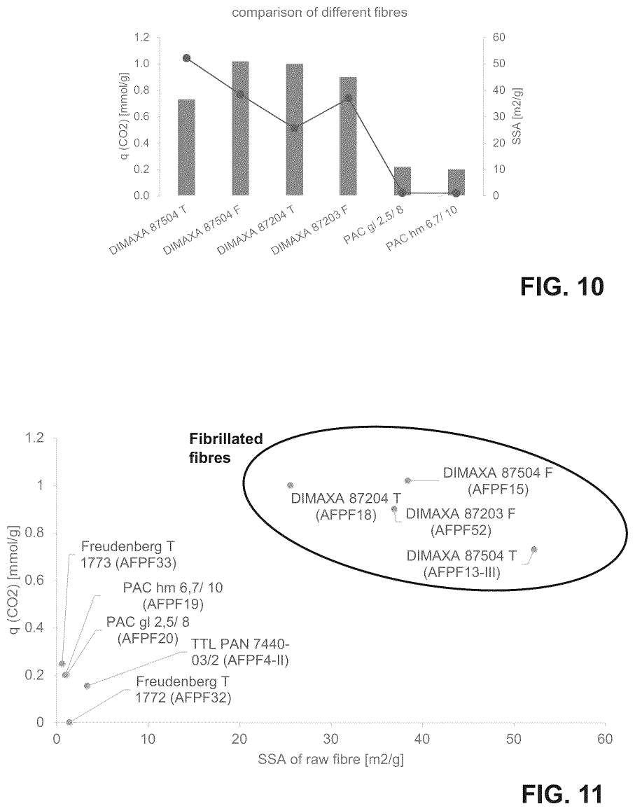

Further, a series of sorbent materials was prepared at standard conditions with these fibres. The results are summarized in FIG. 10. While no direct correlation between SSA of the raw fibre and the CO2 capacity of the functionalized fibre is observed, it is apparent that only the fibrillated DIMAXA fibres yield materials with satisfying CO2 equilibrium capacities. The non-fibrillated fibres show only a negligible CO2 uptake under the same conditions.

The observation that only fibrillated work satisfyingly as AFPF-sorbents is further illustrated in FIG. 11. The CO2 adsorption capacity of various AFPF materials is drawn as function of the SSA of the underlying raw fibre. In addition to the previously mentioned results, it also contains the result for selected aminated commercial PAN fabrics. These fabrics also consist of non-fibrillated fibres with a relatively low SSA and show a low CO2 capacity.

Overall, it can be concluded that fibrillation is an important property that distinguishes AFPF materials with good capture performance.

When examined further, differences between different types of fibrillated DIMAXA fibres were found. These fibres are available in several varieties. The most important differentiating property is the degree of fibrillation which in turn is related to the water retention capacity of the PAN fibre pulp measured in the Schopper-Riegler (SR) value. This value is given in the digits 3 & 4 of the number code belonging to a DIMAXA fibre. Another parameter is the length of the base fibre, deciphered in 5th digit of the product code. Presumably this property is of lesser importance to us since the fibres get shorted during the fibrillation procedure anyways. Finally, the fibres can be procured in a moist state (“F”, german “feucht”) in which the process water from fibrillation is only pressed off (solid content ˜50%) or in a dried state (“T”, german “trocken”; solid content ˜95-100%).

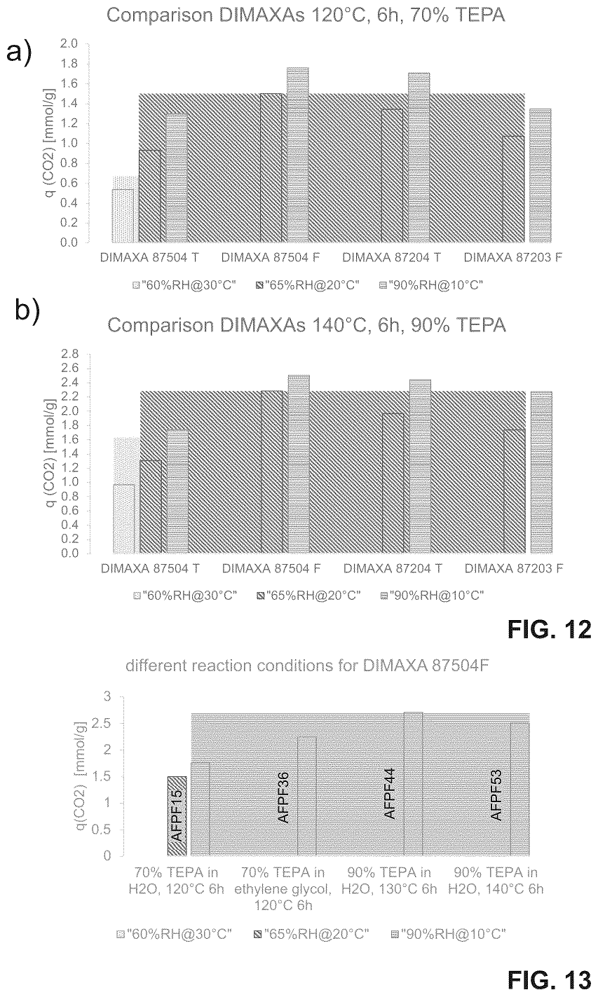

A total of four different DIMAXA fibres was investigated (87504 F/T, 87204T, 87203F): two with an SR of 20 and two with an SR of 50, both in a moist (F) and in a dry state (F). The fibres had a starting length of 4 mm before fibrillation, only the moist (F) 20 SR sample started from 3 mm long fibres. All four fibre types were investigated thoroughly by preparing sorbents in two different condition sets: a) standard conditions (120° C., 70% v/v TEPA, 6 h reaction time) and b) improved conditions (140° C., 90% v/v TEPA, 6 h reaction time). In agreement with previous observations the sorbents synthesized at higher temperature and with a higher TEPA concentration showed a higher CO2 uptake. In all cases the CO2 uptake was dependent on the climatic conditions and the colder and more humid the adsorption air was the higher was the observed CO2 adsorption capacity, see FIG. 12. Interestingly, for DIMAXA 87504 the moist (F) variety yielded better sorbents than the dry (T) variety. Comparing the two dry base fibres shows a clear advantage for the fibre with the lower fibrillation (DIMAXA 87204T) while for the moist varieties the more strongly fibrillated fibre shows the better results (DIMAXA 87504F). Interestingly, these trends could be observed very similarly in both investigated synthesis conditions. This is in alignment with the previous discussion that the overall best results were achieved with more strongly fibrillated fibres (DIMAXA 87504T). The better performance of sorbents based on moist fibres in the one case might result from more favourable reaction conditions e.g. improved submersion, wetting and generally PAN-fibre amine-solution contact.

Finally, we combined the most promising synthesis conditions as determined above for dry DIMAXA 87504 T with the most promising fibre type, moist DIMAXA 87504 F (see FIG. 13). Similar to the dry fibres, the best CO2 uptake performance was obtained when modifying the fibres in 90% aq. TEPA, 130° C. oilbath, 6 h reaction time. Under the most favourable adsorption conditions investigated these fibres (AFPF44) adsorb up to 2.7 mmol_CO2/g_Sorbent.

### Commercial PAN Fabrics

To produce structured adsorbers from PAN, a variety of commercially available woven and non-woven PAN fabrics was procured and functionalized under standard conditions (70% v/v TEPA in H₂O, 120° C. oil bath, 6 h reaction time). For most of the materials no significant CO2 uptake was measured. Only one sample AFPF33 showed a small uptake. From the experiments it can be concluded that the poor performance of commercial PAN fabrics is a consequence of inherent fibre properties and not of the arrangement of fibres into fabrics.

### Experimental Section

### Synthetic Protocol(s)

All AFPF (amine functionalized PAN fibre) materials given above were prepared as detailed below.

A 500 mL three-necked roundbottom flask is loaded with pristine PAN fibres (typically 10.0 g dry weight) and aqueous amine solution of the required concentration in deionized water (DI-H₂O) (typically 300 mL). A reflux condenser is mounted, the reaction mixture mechanically stirred with an overhead stirrer and an oil bath is installed to heat the reaction mixture to the desired reaction temperature. During the first two hours, a gradual change of color from colorless to bright yellow or orange can be observed and a viscous paste is formed. After the synthesis time has passed, the oil bath is removed, and the flask is left to cool down until it can be handled. Additionally, for improved handling, the suspension is diluted with DI-H₂O (200 mL) to reduce viscosity. The mixture is filtered through a Buchner funnel (MN615 filter, or preferentially GE Whatman 589/1) with vacuum suction and the fibres are washed 5-6 times by repeatedly suspending in DI-H₂O (800 mL each run) and vacuum-filtering as before until the filtrate is neutral as measured with a pH strip. Then, the fibres are washed with EtOH (800 mL) to remove residual water to prevent the formation of clumps during the drying process. The fibres are dried in vacuo (100 mbar) at 40° C. overnight.

The “standard conditions” used were 70% v/v amine concentration (unless stated otherwise, TEPA was employed (technical grade, Acros Organics)), 120° C. oil bath temperature and 6 hours reaction time. In variations of the standard experiment the general procedure remained the same and parameters were changed as reported. When ethylene glycol was employed as solvent it was only used to dilute the amine (TEPA) during the reaction, the subsequent washing during the work-up was done with DI-H₂O. For a reaction in N2 atmosphere the reaction mixture and vessel were purged with N2 prior to heating up and a balloon filled with N2 was mounted during the reaction. For modifying commercial PAN fabrics, pieces of said fabrics were placed in a excess of amine solution and treated as described under standard conditions. For the work up, the fabrics were washed as well in water but the washing liquid was removed by pressing out instead of filtering off.

### CO2 Uptake Measurements

For the synthesis optimization (FIG. 2, 3, 5-11) the CO2 adsorption capacity of prepared sorbents was measured in CO2 adsorption/desorption device A with a square measuring cell of 35 mm×35 mm inner size and a height of 33 mm which is filled with 3-4 g fibre sorbent. The measurement is initiated by a desorption step in which the sorbent bed is heated to 94° C. in an air stream (2 NL/min) for 75 min. After cooling to 30° C. the sorbent bed is exposed to a flow of 2 NL/min of air at 30° C. and 60% RH containing 450 ppm CO2 for a duration of 600 min. The amount of CO2 adsorbed during this second step is determined by integration of the signal of an infrared sensor measuring the CO2 content of the air leaving the said measuring cell and is referenced to the dry mass of the sorbent employed for the measurement.

Additionally, selected sorbents were tested under variating climatic conditions CO2 adsorption/desorption device B. In this device about 1 g of fibre sorbent is place in a tubular double wall reactor (Ø=10 mm, h˜10 cm) which is flown-through by an oil-stream feeding from one of two thermostatic reservoirs. Initially, the sorbent is desorbed by switching this oil flow to 100° C. for 45 min while passing an air stream (2 NL/min) through the reactor. Afterwards the oil stream is switched to feed from a reservoir at colder temperature and the reactor is cooled without gas-flow. After reaching a set threshold temperature, the sorbent is exposed to a 2 NL/min flow of humidified air containing 450 ppm CO2 for a duration of 300 min. According to the desired climatic conditions the temperature of the oil stream around the reactor and the amount of water dosed for humidification are set. The system relies solely on set values and does not actively control the climatic conditions which is why the real conditions in the reactor can differ from the set values reported in “quotation marks”. The amount of CO2 adsorbed during the second step is determined by integration of the signal of an infrared sensor measuring the CO2 content of the air leaving the said measuring tubular reactor and is referenced to the dry mass of the sorbent employed for the measurement.

### Specific Surface Area (SSA) Measurements by Nitrogen Adsorption

Nitrogen adsorption measurements were performed at 77K on a Quantachrome Autosorb iQ. A sample size of 0.1-0.3 g was used, and the materials were degassed at 90° C. for 12 hours under vacuum prior to use. To determine the specific surface area (SSA) BET (Brunauer, Emmett, Teller) surface area analysis was conducted according to ISO 9277.

### Grammage and Thickness

The grammage and thickness of the woven, nonwoven, knitted or paper-like structures herein described has been selected to offer the maximum output for a given process and concentration of species to capture. All such capture processes, and specifically those around direct air capture must respect technically and energetically imposed pressure drop limits leading. Correspondingly, there is a maximum of capture throughput which is found at the maximum allowable pressure drop and the highest allowable effective material density (considering the spacing of the array). Materials which are significantly thicker or have a far higher grammage than noted—and therefore a higher possible species loading per volume of material—require a greater amount of gas flow to reach a cyclically attractive loading. However, respecting the above mentioned pressure drop limits leads either to longer cycle times or an increase in spacing of the structures in the array. Both measures reduce process output. Conversely, materials which are significantly thinner or with a far lower grammage have the opposite problem (in addition to being far more difficult to handle and arrange); the resulting narrow array spacing or short cycles times cannot offset the resulting low effective material density leading again to a reduce output when moving away from the range of grammage and thickness herein disclosed.

### Fleece Preparation and Characterization

Wet-Laid Fleeces were Prepared Using the Following Procedure:
1. Preparation of fibre suspension: Suspend desired amount of fibrillated AFPF fibres for targeted grammage and composition in 2l water using an Ultra-Turrax mixer (1 min, 8000 rpm); possibly add potential additive(s) such as binder fibres and mixing-in with the Ultra-Turrax (30 sec, 8000 rpm).
2. Sheet formation on a Rapid-Kö then sheet former fill sheet former with 4 L water, switch on swirling air stream; add fibre suspension and swirl for 1 min; rest for 3 sec before starting to drain water and lay-down fibres on sieve of sheet former to former circular sheets with a diameter of 20 cm.
3. Drying fleeces in convection oven at 80° C. for 60 min
4. Thermo-bonding fleeces by one of the following options
   a. Passing fleece through a 2-drum calendar (Mathis A G, Switzerland) at 115-135° C.; drum speed of 1 m/min and 0.2-0.5 mm gap
   b. Passing fleece through Thermofix double-belt press (Schott&Meissner GmbH, Germany) at 125-135° C., belt speed 1 m/min, no gap
   c. Activating binding agents at 140° C. in a convection oven for 1 min.

Fleeces were prepared using AFPF fibres based on STW DIMAXA 8750 F PAN fibres aminated in 90% vol aqueous solution of TEPA at 130° C. for 6 h.

The following binding agents were employed, on their own or in combination (this list is not limiting and serves as illustration only):
Bico-fibre PET/PET Kuraray, 5 mm, 1.0 dtex, melting point sheath 110° C.
Bico-fibre PET/PE Trevira 255, 6 mm, 1.3 dtex, melting point sheath 127° C.
PET fibre Advansa 12 mm, 3.3 dtex
PET fibre Barnet 12 mm, 6.7 dtex
PET fibre STW 6 mm, 1.7 dtex
Acronal DS 3558 (BASF Germany) as 15 g/l or 40 g/l aqueous suspension
Lefasol VD74/1 (Lefatex Chemie GmbH, Germany) as 15 g/aqueous suspension

Consequently, obtained fleeces were tested for grammage in g/m2 following DIN EN 12127, for thickness in mm following DIN EN ISO 9073-2, for air permeability in mm/s at 100 Pa following DIN EN ISO 9237, for tensile strength in wet state in N following DIN EN 29073-3 and tear strength in wet state in N following DIN EN ISO 9073-4. In a preferred embodiment (fleece sample A) 4.52 g AFPF fibres and 1.13 g of Bico-fibre PET/PET Kuraray (5 mm, 1.0 dtex, melting point sheath 110° C.) are used for step 1 of the fleece preparation above, followed by treatment according to step 2, 3 and 4b at a temperature of 125° C.

In another example (fleece sample B)) 4.52 g AFPF fibres and 0.85 g of Bico-fibre PET/PET (Kuraray, 5 mm, 1.0 dtex, melting point sheath 110° C.) and 0.28 g PET fibre (STW, 6 mm, 1.7 dtex) are used for step 1 of the fleece preparation above, followed by treatment according to step 2, 3 and 4b at a temperature of 125° C.

The obtained fleeces were characterized following the methods outlined above and the results are given in table 3.

TABLE 3
Characterization of the fleeces

| | | | | Tensile | Tear |
|---|---|---|---|---|---|
| | | | Air | strength | force |
| | Grammage | Thickness | permeability | (wet) | (wet) |
| Fleece | 180 g/m2 | 0.558 mm | 20.9 mm/s | 73.7 N | 2.64 N |
| sample A | | | (at 100 Pa) | | |
| Fleece | 180 g/m2 | 0.686 mm | 34 mm/s | 50.9 N | 2.34 N |
| sample B | | | (at 100 Pa) | | |

### Cyclic Adsorption Performance:

Fleece sample B was further tested in a cyclic adsorption process. A parallel passage reactor with an inlet area of 41 mm×47 mm and a depth of 40 mm was assembled such that sheets from fleece sample B were stacked with a 1 mm spacing. The cyclic adsorption/desorption capacity was measured in consecutive runs at relative humidity of the ambient air of approximately 56% and temperature of approximately 18° C. at a flow of approximately 20 NI (norm liter, at 0° C. and 1013.25 Pa). The desorption process was performed using a warm fluid to increase the temperature of the sorbent. In this specific example, saturated steam was employed. The sorbent bed was first adsorbed for 240 min using ambient air Once the adsorption was completed, the pressure of the system was brought down to 150 mbarabs. As soon as the pressure is reached, saturated steam is supplied to the sorbent bed up to reaching a temperature of ca 95° C. and the sorbent bed is purged with steam for 5 min. After that, the sorbent was brought to 70 mbarabs until a temperature of 60° C. is reached.

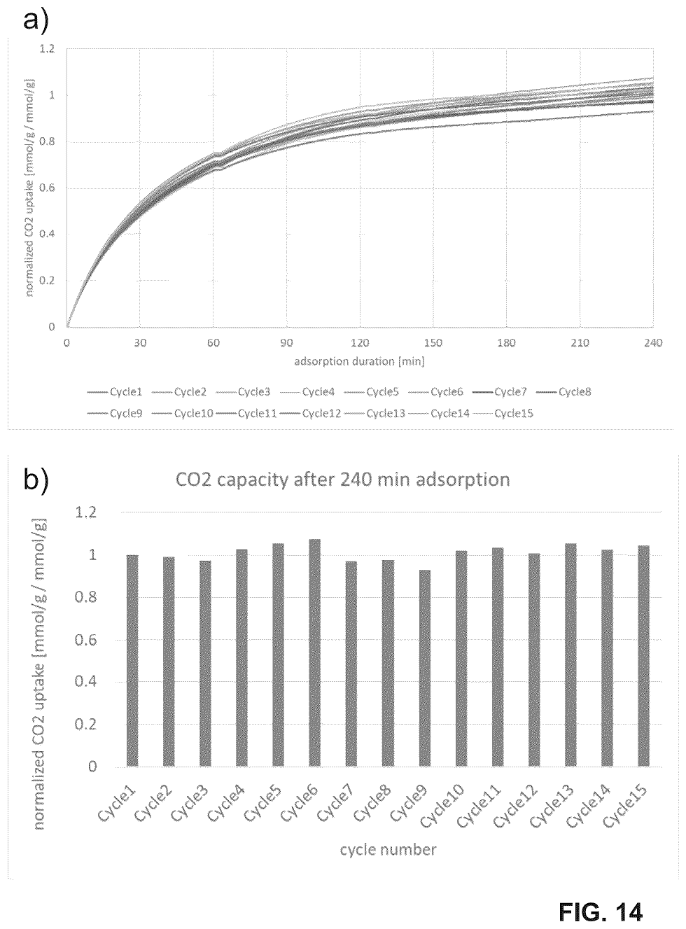

FIG. 14 shows the CO2 uptake curves for 15 consecutive cycles. It can be seen that approximately 80% of the total capacity is already reached after 90 min adsorption indicating fast adsorption kinetics. After 15 cycles no degradation can be seen indicating good cyclic stability of the sorbent.

1. Method for the production of amine functionalized polyacrylonitrile fibres, preferably for direct air capture, wherein pristine polyacrylonitrile fibres are combined with a solution of at least one of tetraethylenepentamine and pentaethylenehexamine at a concentration of tetraethylenepentamine, pentaethylenehexamine, or the combination thereof, of at least 80% v/v, and wherein the mixture is then kept at a temperature in the range of 120-160° C. for a time span of at least 4 hours.

2. Method according to claim 1, wherein the concentration of the solution of tetraethylenepentamine is at least 85% v/v.

3. Method according to claim 1, wherein the solution of tetraethylenepentamine is in water or an alcoholic organic solvent, or in a mixture thereof.

4. Method according to claim 1, wherein the solution of tetraethylenepentamine is a purely aqueous solution.

5. Method according to claim 1, wherein the mixture is kept at a temperature in the range of 125-160° C.

6. Method according to claim 1, wherein the pristine polyacrylonitrile fibres are fibrillated fibres.

7. Method according to claim 1, wherein the pristine polyacrylonitrile fibres have a specific surface area of at least 10 m²/g.

8. Method according to claim 1, wherein the pristine polyacrylonitrile fibres have a Schopper-Riegler value in the range of 18-70° SR.

9. Method according to claim 1, wherein subsequently or before the fibres are either processed to form a cohesive structure.

10. Method according to claim 1, wherein subsequently or before the fibres are processed to form a nonwoven structure in a dry or wet laying process.

11. Fibre or yarn, woven, nonwoven, knitted or paper-like cohesive, comprising or consisting of amine functionalized polyacrylonitrile fibres produced according to a method according claim 1, wherein the amine functionalized polyacrylonitrile fibres have been obtained from pristine polyacrylonitrile fibres by combination with a solution of at least one of tetraethylenepentamine and pentaethylenehexamine at a concentration of tetraethylenepentamine, pentaethylenehexamine, or the combination thereof, of at least 80% v/v, and keeping the mixture at a temperature in the range of 120-160° C. for a time span of at least 4 hours.

12. Nonwoven, cohesive, self-supporting structure comprising fibres or yarns according to claim 11.

13. Air permeable container containing fibres or yarn and/or a woven, nonwoven, knitted or paper-like cohesive structure according to claim 11.

14. Method of using fibre-based structure according to claim 11 for separating gaseous carbon dioxide from a gas mixture.

15. A method according to claim 14 for separating gaseous carbon dioxide from a gas mixture, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit essentially under ambient atmospheric pressure conditions and ambient atmospheric temperature conditions in an adsorption step;
(b) isolating said sorbent material with adsorbed carbon dioxide in said unit from said flow-through;
(c) inducing an increase of the temperature of the sorbent material to a temperature between 60 and 110° C., starting the desorption of CO2;
(d) extracting at least the desorbed gaseous carbon dioxide from the unit and separating gaseous carbon dioxide in or downstream of the unit;
(e) bringing the sorbent material essentially to ambient atmospheric temperature conditions and ambient atmospheric pressure conditions;
wherein said sorbent material comprises or consists of a fibre-based structure according to claim 11.

16. Unit for separating gaseous carbon dioxide from a gas mixture, comprising at least one reactor unit containing sorbent material suitable and adapted for flow-through of said gas mixture,
wherein the reactor unit comprises an inlet for said gas mixture, and an outlet for said gas mixture,
wherein the reactor unit is heatable to a temperature of at least 60° C. for the desorption of at least said gaseous carbon dioxide and the reactor unit being openable to flow-through of the gas mixture, and for contacting it with the sorbent material for an adsorption step,
wherein the sorbent material is taking the form of a woven, nonwoven, knitted or paper-like cohesive according to claim 11,
at least one device, for separating carbon dioxide from water.

17. Method according to claim 1, wherein the mixture is stirred at a temperature in the range of 120-160° C. for a time span of at least 4 hours.

18. Method according to claim 1, wherein the concentration of the solution of tetraethylenepentamine is at least in the range of 85-98% v/v, or 85-95% v/v or 85-90% v/v.

19. Method according to claim 1, wherein the mixture is stirred at a temperature in the range of 125-160° C. for a time span in the range of 4-8 hours.

20. Method according to claim 1, wherein the mixture is stirred at a temperature in the range of 130-150° C. or 130-140° C., for a time span in the range of 5-7 hours.

21. Method according to claim 1, wherein the pristine polyacrylonitrile fibres, in the form of fibrillated fibres, have a specific surface area of at least 10 m²/g.

22. Method according to claim 1, wherein the pristine polyacrylonitrile fibres have a specific surface area of at least 20 m²/g, or in the range of 20-60 m²/g, or in the range of 25-45 m²/g.

23. Method according to claim 1, wherein the pristine polyacrylonitrile fibres, in the form of fibrillated fibres, have a Schopper-Riegler value in the range of 18-70° SR.

24. Method according to claim 1, wherein the pristine polyacrylonitrile fibres have a Schopper-Riegler value in the range of 20-60° SR.

25. Method according to claim 1, wherein subsequently or before the fibres are either processed to form a cohesive, self-supporting structure, in the form of a yarn, woven, nonwoven, knitted or paper-like structure or a combination thereof, and/or are filled into an air permeable container, suitable and adapted for a direct air capture process.

26. Method according to claim 1, wherein subsequently or before the fibres are processed to form a nonwoven structure in a dry or in a wet laying process including additional binding elements.

27. Method according to claim 1, wherein subsequently or before the fibres are processed to form a nonwoven structure in a dry or in a wet laying process followed by applying at least one of heat, irradiation and pressure for activating the binding elements and/or calendaring.

28. Method according to claim 1, wherein subsequently or before the fibres are processed to form a nonwoven structure in a dry or in a wet laying process including additional binding elements, wherein the binding elements take the form of fibres different from polyacrylonitrile fibres, dissolved or suspended binding agents and/or binder particles, said wet laying process involving mesh forming from suspended fibres and dewatering, followed by applying at least one of heat, irradiation and pressure for activating the binding elements and/or calendaring.

29. Fibre or yarn, woven, nonwoven, knitted or paper-like cohesive, self-supporting structure, according to claim 11.

30. Method according to claim 14 for separating gaseous carbon dioxide from at least one of ambient atmospheric air, flue gas and biogas, said method using a temperature, vacuum, or temperature/vacuum swing process.

31. Method according to claim 14 for direct air capture.

32. Method according to claim 30, said method using a process in which injecting a stream of partially or fully saturated or superheated steam by flow-through is used for inducing an increase of the temperature of the sorbent material to a temperature between 60 and 110° C., starting the desorption of CO2, wherein in the adsorption step the method is carried out under conditions that the gas mixture or the ambient atmospheric air passing through the sorbent material at least during 5% or 10% or 50% of the cycles in one day, one month and/or or over one year, has a relative humidity varying in the range of 5-100% RH, 10-98% RH or 20-95% RH, or in the range of 30-95%.

33. Unit according to claim 16, in the form of a direct air capture unit, comprising at least one reactor unit containing sorbent material suitable and adapted for flow-through of said gas mixture,
wherein the reactor unit comprises an inlet for ambient air, and an outlet for for ambient air during adsorption,
wherein the reactor unit is heatable to a temperature of at least 60° C. for the desorption of at least said gaseous carbon dioxide and the reactor unit being openable to flow-through of the ambient atmospheric air, and for contacting it with the sorbent material for an adsorption step, wherein the reactor unit is further evacuable to a vacuum pressure of 400 mbar (abs) or less,
wherein the sorbent material takes the form of an adsorber structure comprising an array of individual adsorber elements, taking the form of a woven, nonwoven, knitted or paper-like cohesive, self-supporting structure according to claim 11 or 12 or of an air permeable container according to claim 13, which offers selective adsorption of CO2 in the presence of moisture or water vapor, wherein the adsorber elements in the array can be arranged essentially parallel to each other and spaced apart from each other forming parallel fluid passages for flow-through of ambient atmospheric air and/or steam,
at least one condenser, for separating carbon dioxide from water.

34. Unit according to claim 16, wherein at the gas outlet side of said condenser, there is at least one of, or both of a carbon dioxide concentration sensor and a gas flow sensor for controlling the desorption process.

35. Method according to claim 1, wherein the amine functionalized polyacrylonitrile fibres are for direct air capture.
